(19) United States
(12) Patent Application Publication
(10) Pub. No.: US 2012/0259924 A1
(43) Pub. Date: Oct. 11, 2012

(54) Method and apparatus for providing summary information in a live media session

(75) Inventors: Deepti Patil, San Jose, CA (US); Satish Gannu, San Jose, CA (US)

(73) Assignee: CISCO TECHNOLOGY, INC., San Jose, CA (US)

(21) Appl. No.: 13/066,029

(22) Filed: Apr. 5, 2011

(51) Int. Cl. G06F 15/16

(52) U.S. Cl. 709/206; 709/219

(57) ABSTRACT

In one embodiment, a method includes receiving media from a live media session, processing the media to generate summary information for the live media session, and transmitting the summary information for a specified segment of the live media session to a user during the live media session. An apparatus is also disclosed.

### TECHNICAL FIELD

The present disclosure relates generally to communication networks, and more particularly, to providing summary information for a media session.

### BACKGROUND

The use of live media sessions has become increasingly popular as a way to reduce travel expense and enhance collaboration between people from distributed geographic locations. Live broadcasts or conferences may be used, for example, for meetings (e.g., all-hands, town-hall), remote training lectures, classes, or other purposes. A common occurrence with a live media session is that a participant has to join in late after the session has started. A participant may also miss a portion of the live media session. This may result in disturbance of others if the participant inquires as to what has been missed. If the participant does not ask for an update, he may lose context and have trouble following the rest of the session. A participant may also have to step out of an ongoing session, in which case he does not know what is being missed.

### BRIEF DESCRIPTION OF THE DRAWINGS

FIG. 1 illustrates an example of a network in which embodiments described herein may be implemented.

FIG. 2 depicts an example of a network device useful in implementing embodiments described herein.

FIG. 3 is a flowchart illustrating an overview of a process for providing summary information in a live media session, in accordance with one embodiment.

FIG. 4 is a flowchart illustrating a process for providing summary information to a participant joining the media session late or providing summary information on demand, in accordance with one embodiment.

FIG. 5 is a flowchart illustrating a process for setting an alert for notification upon the occurrence of an event in the live media session, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises receiving media from a live media session, processing the media to generate summary information for the live media session, and transmitting the summary information for a specified segment of the live media session to a user during the live media session.

In another embodiment, an apparatus generally comprises a processor for processing media received from a live media session to generate summary information for the live media session and transmitting summary information for a specified segment of the live media session to a user during the live media session. The apparatus further comprises memory for storing the processed media.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

The embodiments described herein provide summary information for a live media session during the media session. For example, a user may automatically receive a summary of the media session from a start of the session until the point at which the user joined the session, or may request summary information for a specific segment of the media session, as described below. The user can therefore catch up on a missed portion of a media session as soon as he joins the live session and does not need to wait until the media session is over to receive a summary. The user may also set an alert for an event that may occur later in the media session, so that a notification can be sent to the user upon occurrence of the event. This allows the user to leave the live media session and return to the session if a notification is received.

As described in detail below, the summary information may be a transcription, keywords, identification of speakers and associated speech time, audio or video tags, notification of an event occurrence, or any other information about the media session that can be used by a participant of the media session.

The term ‘media’ as used herein refers to video, audio, data, or any combination thereof (e.g., multimedia). The media may be encrypted, compressed, or encoded according to any format. The media content may be transmitted as streaming media or media files, for example.

The term ‘media session’ as used herein refers to a meeting, class, conference (e.g., video conference, teleconference), broadcast, telecast, or any other communication session between a plurality of users transmitted using any audio or video means, including signals, data, or messages transmitted through voice or video devices. The media session may combine media from multiple sources or may be from a single source. The media session is ‘live’ from the start of the session (e.g., transmission of audio or video stream begins, start of broadcast/telecast, one or more participants logging on or dialing in to a conference, etc.) until the session ends (e.g., broadcast/telecast ends, all participants log off or hang up, etc.). A participant of the media session may be an active participant (e.g., receive and transmit media) or a nonactive participant (e.g., only receive media or temporarily located remote from the media session).

The embodiments operate in the context of a data communications network including multiple network devices (nodes). Some of the devices in the network may be appliances, switches, routers, gateways, servers, call managers, service points, media sources, media receivers, media processing units, media experience engines, multimedia transformation units, multipoint conferencing units, or other network devices.

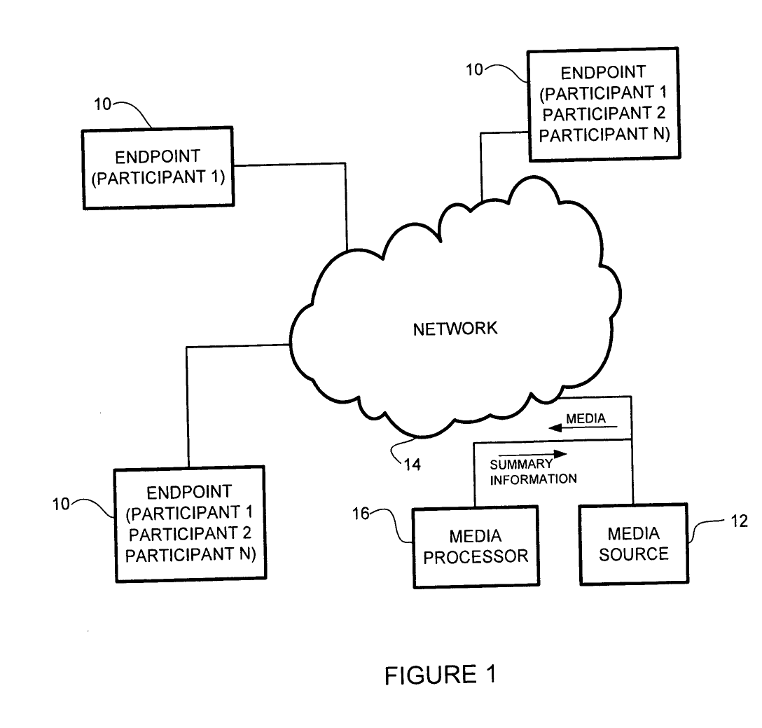

Referring now to the drawings, and first to FIG. 1, an example of a network in which embodiments described herein may be implemented is shown. A plurality of endpoints (e.g., media sources/receivers) 10 are in communication with one or more media sources 12 via network 14. The network 14 may include one or more networks (e.g., radio access network, public switched network, local area network, wireless local area network, virtual local area network, virtual private network, metropolitan area network, wide area network, enterprise network, Internet, intranet, or any other network). A media processor 16 is interposed in a communication path between the media source 12 and endpoints 10. The nodes 10, 12, 16 are connected via communication links (wired or wireless). Media flow paths between the endpoints 10 and media source 12 may include any number or type of intermediate nodes (e.g., routers, switches, gateways, servers, bridges, or other network devices operable to exchange information in a network environment), which facilitate passage of data between the nodes.

The endpoints 10 are configured to originate or terminate communications over the network 14. The endpoints 10 may be any device or combination of devices configured for receiving, transmitting, or receiving and transmitting media flows. For example, the endpoint 10 may be a personal computer, media center device (e.g., TelePresence device), mobile device (e.g., phone, personal digital assistant), or any other device capable of engaging in audio, video, or data exchanges within the network 14. The endpoints 10 may include, for example, one or more processor, memory, network interface, microphone, camera, speaker, display, keyboard, whiteboard, and video conferencing interface. There may be one or more participants (users) located or associated with each endpoint 10.

The endpoint 10 may include a user interface (e.g., graphical user interface, mouse, buttons, keypad) with which the user can interact with to request summary information from the media processor 16. For example, upon joining a live media session, the user may be presented with a screen displaying options to request summary information. The user may specify, for example, the type of summary information (e.g., transcript, speakers, keywords, notification, etc.) and may also specify the segment of the media session for which the summary is requested (e.g., from beginning to time at which participant joined the media session, segment at which a specific speaker was presenting, segment for a specified time period before and after a keyword, etc.). The endpoint 10 may also include a display screen for presenting the summary information. For example, the summary information may be displayed within a window (note) or side screen (side bar) along with a video display of the live media session. The summary information may also be displayed on a user device (e.g., personal computer, mobile device) associated with the participant and independent from the endpoint 10 used in the media session.

The media source 12 is a network device operable to broadcast live audio, video, or audio and video. The media source 12 may originate a live telecast or may receive media from one or more of the endpoints and broadcast the media to one or more of the endpoints. For example, the media source 12 may be a conferencing system including, a multipoint conferencing unit (multipoint control unit) (MCU) configured to manage a multi-party conference by connecting multiple endpoints 10 into the same conference. The MCU collects audio and video signals transmitted by conference participants through their endpoints 10 and distributes the signals to other participants of the conference.

The media processor 16 is a network device (e.g., appliance) operable to process and share media across the network 14 from any source to any endpoint. As described in detail below, the media processor 16 processes the live media to provide summary information to a participant. The media processor 16 may also be configured to perform other processing on the media, including, for example, media transformation, pulse video analytics, integrating video into the media session, conversion from one codec format to another codec format, etc.

The media processor 16 is located between the media source 12 and the endpoints 10 and may be implemented, for example, at the media source, at one or more of the endpoints, or any other network device interposed in the communication path between the media source and endpoints. Also, one or more processing components of the media processor 16 may be located remote from the other components. For example, a speech-to-text converter may be located at the media source 12 and a search engine configured to receive and search the text may be located at one or more endpoints 10 or other network device.

It is to be understood that the network shown in FIG. 1 and described herein is only an example and that the embodiments described herein may be implemented in networks having different network topologies and network devices, without departing from the scope of the embodiments.

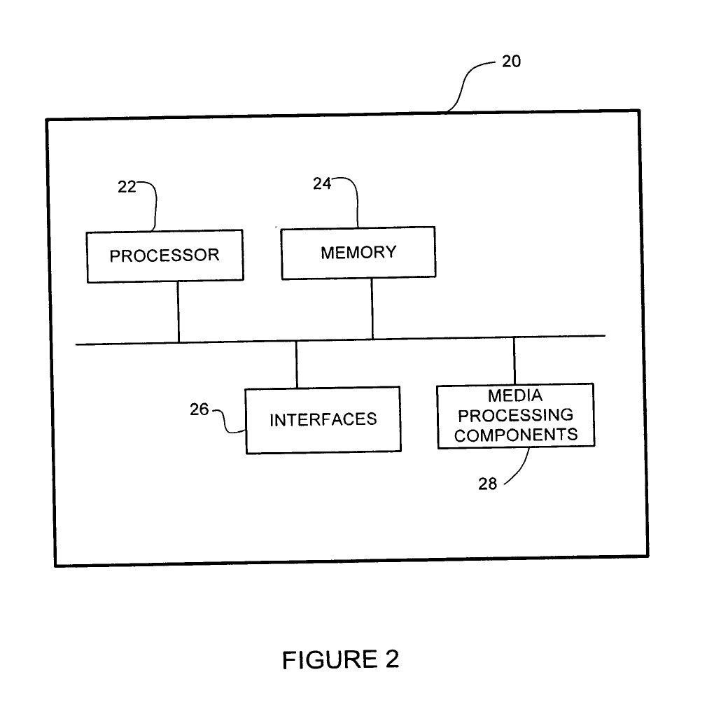

An example of a network device 20 (e.g., media processor) that may be used to implement embodiments described herein is shown in FIG. 2. In one embodiment, network device 20 is a programmable machine that may be implemented in hardware, software, or any combination thereof. The device 20 includes one or more processors 22, memory 24, network interfaces 26, and media processing components 28. Memory 24 may be a volatile memory or non-volatile storage, which stores various applications, modules, and data for execution and use by the processor 22.

Logic may be encoded in one or more tangible computer readable media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The network interfaces 26 may comprise one or more wireless or wired interfaces (linecards, ports) for receiving signals or data or transmitting signals or data to other devices. The interfaces 26 may include, for example, an Ethernet interface for connection to a computer or network.

The media processing components 28 may include, for example, speech-to-text converter, search engine, speaker identifier (e.g., voice or face recognition application), tagging engine, or any other media processing components that may be used to generate summary information from the live media. Examples of media processing components 28 are described further below.

The network device 20 may further include any suitable combination of hardware, software, algorithms, processors, devices, components, or elements operable to facilitate the capabilities described herein. It is to be understood that the network device 20 shown in FIG. 2 and described above is only one example and that different configurations of network devices may be used.

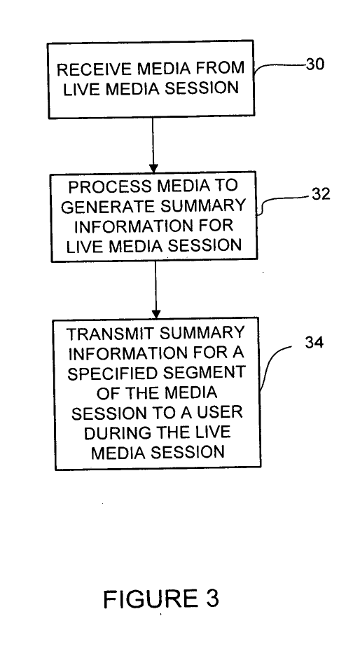

FIG. 3 is a flowchart illustrating an overview of a process for providing summary information in a live media session, in accordance with one embodiment. At step 30, the media processor 16 receives media from a live media session. The media processor 16 processes the media to generate summary information for the live media session (step 32) and transmits at least a portion of the summary information for a specified segment (e.g., missed portion or requested portion) of the media session to a user (participant of media session) during the live media session (step 34).

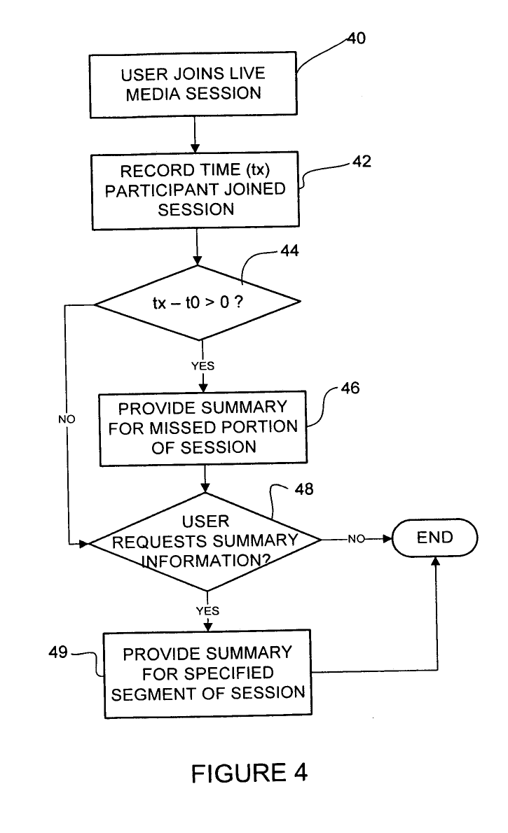

As described below with respect to the flowchart of FIG. 4, the summary information may be automatically generated upon a user joining a media session late or may be transmitted on demand in response to a request from a user for summary information for a specific segment of the media session. The summary information may be displayed on a screen at the endpoint 10 used to transmit the media session to the user or may be delivered to the user (e.g., e-mail or text message to user address) and displayed on another device. Upon receiving the summary information, the user may also request additional information for one or more segments of the live media session.

FIG. 4 is a flowchart illustrating a process for providing summary information to a participant joining the media session late or providing summary information on demand, in accordance with one embodiment. A live media session begins at time t0. At step 40, a participant joins the live media session. The participant may, for example, log onto a user account (e.g., on a personal computer or other media device) or dial into a telephone conference. The time (tx) that the participant joined the session is recorded (step 42) via a timestamp, for example. The participant may be identified by the timestamp indicating when he joined the session or may also be identified by other means (e.g., e-mail address, user name, telephone number, voice recognition, face recognition, etc.). The user may also be associated with one of the endpoints 10 in the media session.

If the participant joins the media session after the start of the media session (tx−t0>0) (step 44), summary information may be automatically sent (or sent on demand) to the user during the live media session for the missed segment of the session (t0 to tx) (step 46). If the difference between the joining time (tx) of the media session and the start time (t0) is equal to (or less than) zero, there is no missed segment to send and the process moves on to step 48. At any time during the media session, the user may request on demand summary information for a specified segment of the media session (steps 48 and 49). Even if the user does not leave the media session, he may miss a part of the session, want to check if he heard something correctly, or want to identify a speaker in the session, for example. The user may request a specific segment (e.g., from time x to time y, segment when speaker z was talking, time period before or after a keyword was spoken or a video frame was shown, etc.).

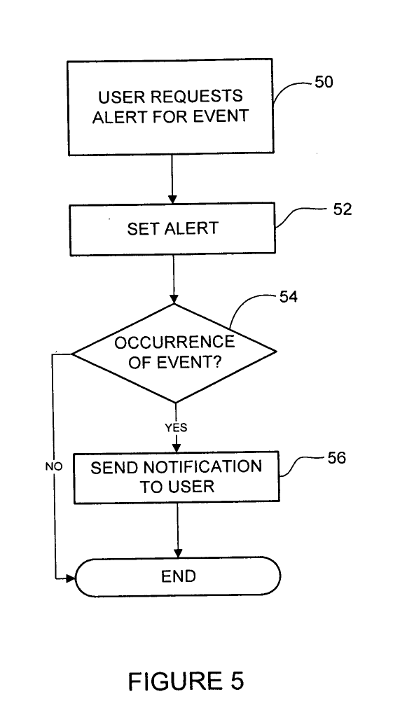

FIG. 5 is a flowchart illustrating a process for providing notification to a user upon the occurrence of an event in the live media session, in accordance with one embodiment. At step 50, the user requests an alert for occurrence of a specific event in the media session. The event may be, for example, identification of one or more keywords (e.g., topics or names displayed in video or spoken in audio), identification of a speaker, or any other event that is identifiable in the media session. For example, a user may want to be notified if speaker z talks, user name is mentioned, or when bonus is discussed. The media processor 16 sets the alert at step 52 (e.g., programs search engine, sets video or audio tagging, set speaker ID recognition, etc.). Upon occurrence of the event (step 54), a notification is transmitted to the user that requested the alert (step 56). If the event does not occur during the media session, the process ends with no notification being sent to the user. The notification may be sent, for example, to the user's mobile device. The user may provide an address (e.g., e-mail, phone number) at which to receive the notification when the alert is requested or the media processor 16 may store in memory contact information for the user, which may be identified when he joins the session, as previously discussed.

It is to be understood that the processes illustrated in FIGS. 3, 4, and 5 and described above are only examples, and that steps may be modified, added, removed, or combined, without departing from the scope of the embodiments.

The summary information may include any synopsis attributes (e.g., transcript (full or partial), keywords, video tags, speakers, speakers and associated time, list of ‘view-worthy’ sections of session, notification for event occurrence, etc.) that may be used by the participant to gain insight into the portion of the session that he has missed or needs to review. The following provides examples of processing that may be performed on the live media to provide summary information. It is to be understood that these are only examples and that other processing or types of summary information may be used without departing from the scope of the embodiments.

Speech-to-text transcription may be performed to extract the content of the media session. A full transcript may be provided or transcript summarization may be used. A transcript summary may be presented, for example, with highlighted keywords that can be selected to request a full transcript of a selected section of the transcript summary. The transcript is preferably time stamped. The speech-to-text converter may be any combination of hardware, software, or encoded logic, that operates to receive speech signals and generate text that corresponds to the received speech. In one example, speech-to-text operations may include waveform acquisition, phoneme matching, and text generation. The waveform may be broken down into individual phonemes (e.g., eliminating laughter, coughing, background noises, etc.). Phoneme matching can be used to assign a symbolic representation to the phoneme waveform (e.g., using some type of phonetic alphabet). The text generation can map phonemes to their intended textual representation. If more than one mapping is possible, contextual analysis may be used to select the most likely version.

Speaker recognition may also be used to provide summary information such as which speakers spoke during a specified segment of the media session. Speaker recognition may be provided using characteristics extracted from the speaker's voices. For example, the users may enroll in a speaker recognition program in which the speaker's voice is recorded and a number of features are extracted to form a voice print, template, or model. During the media session, the speech is compared against the previously created voice prints to identify the speaker. The speaker may also be identified using facial recognition software that identifies a person from a digital image or video frame. For example, selected facial features from the image may be compared with a facial database.

Media tagging can be used to transform media (video, audio, data) into a text tagged file for use in presenting summary information. A search module can interact with the media tagging module to search information. The tags identified during a specified segment of the media session can be used to provide the user a general idea of what topics were discussed or mentioned in the media session. The tags may be processed, for example, using pulse video tagging techniques.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving media from a live media session;
processing said media to generate summary information for said live media session; and
transmitting said summary information for a specified segment of said live media session to a user during said live media session.

2. The method of claim 1 further comprising receiving a request from the user for said summary information.

3. The method of claim 1 further comprising recording a time the user joins said live media session and wherein said specified segment comprises a segment from the beginning of said live media session to the time the user joined said live media session.

4. The method of claim 3 wherein transmitting said summary information comprises automatically transmitting said summary information to the user after the user joins said live media session.

5. The method of claim 1 wherein said summary information comprises a transcript of said specified segment of said live media session and wherein processing said media comprises converting an audio portion of said live media session to text.

6. The method of claim 1 wherein said summary information comprises speakers in said live media session and wherein processing said media comprises identifying said speakers in said live media session.

7. The method of claim 1 wherein said summary information comprises a plurality of tags and wherein processing said media comprises generating tags for said live media session.

8. The method of claim 1 wherein transmitting said summary information comprises transmitting a notification of an event in said live media session and wherein processing said media comprises searching said received media for said event.

9. The method of claim 8 wherein said event comprises identification of a speaker in said live media session.

10. The method of claim 8 wherein said event comprises identification of a keyword in said live media session.

11. The method of claim 8 wherein transmitting said notification comprises sending a message to the user.

12. The method of claim 1 wherein transmitting said summary information comprises transmitting said summary information to an endpoint at which the user receives said media.

13. An apparatus comprising:
a processor for processing media received from a live media session to generate summary information for said live media session and transmitting said summary information for a specified segment of said live media session to a user during said live media session; and
memory for storing said processed media.

14. The apparatus of claim 13 wherein the processor is configured to transmit said summary information in response to a request from the user for said summary information.

15. The apparatus of claim 13 wherein the processor is further configured to record a time the user joins said live media session and wherein said specified segment comprises a segment from the beginning of said live media session to the time the user joined said live media session.

16. The apparatus of claim 13 wherein said summary information comprises a notification of an event in said live media session and wherein processing said media comprises searching said received media for said event.

17. Logic encoded in one or more tangible computer readable media for execution and when executed operable to:
process media received from a live media session to generate summary information for said live media session; and
transmit said summary information for a specified segment of said live media session to a user during said live media session.

18. The logic of claim 17 wherein said summary information is transmitted in response to a request from the user for said summary information.

19. The logic of claim 17 further comprising logic operable to record a time the user joins said live media session and wherein said specified segment comprises a segment from the beginning of said live media session to the time the user joined said live media session.

20. The logic of claim 17 wherein said summary information comprises a notification of an event in said live media session and wherein processing said media comprises searching said received media for said event.
